(19) United States
(12) Patent Application Publication
(10) Pub. No.: US 2012/0048966 A1
(43) Pub. Date: Mar. 1, 2012

(54) Rotary Atomizer with Metal Foam Inserts

(76) Inventors: John Bulder, Petaling Java (MY); Chris Reijmer, Petaling Jaya (MY)

(21) Appl. No.: 13/062,396

(22) PCT Filed: Sep. 9, 2008
(86) PCT No.: PCT/MY2008/000096

§ 371 Date: May 11, 2011

(51) Int. Cl. B05B 3/02

(52) U.S. Cl. 239/225.1

(57) ABSTRACT

A rotary atomizer is presented comprising a rotor (8), having a plurality of insert holders (20) along the perimeter of rotor (8); and a plurality of metal foam inserts (12) placed between insert holders (20) that act as nozzles of the rotary atomizer. Rotor (8) is characterized in an assembly wherein insert holders (20) secure the position of metal foam inserts (12). Rotor (8) can be disc shaped. A protection plate (10) is fixed to a stationary shaft (1) of the atomizer to prevent physical contact with rotor (8) without obstructing the atomizer output.

### FIELD OF INVENTION

The present invention relates to a device for atomizing liquids, and more specifically to a rotary atomizer with nozzle inserts.

### BACKGROUND TO THE INVENTION

A rotary atomizer is a device to atomize liquids such as water, insecticide, fertilizer or paint Typical atomizers usually have the liquid to be atomized fed near the axis of an atomizer rotor. The rotor has a plurality of holes which act as nozzles. The liquid is then dispersed in a radial direction, as centrifugal force forces the liquid through the nozzles in the rotor. The atomizer rotor can be driven by a propeller, a turbine, a belt or an electrical motor.

U.S. Pat. No. 4,019,684 discloses a rotary atomizer for dispersing liquids, which uses a 6 to 8 inch diameter disc of reticulated metal foam as the atomizing nozzle, whereby the metal foam disc is installed along the perimeter of a rotor, Metal foam makes a suitable nozzle because it is rigid and highly porous.

U.S. Pat. No. 4,927,081 discloses a hand held paint atomizer which uses a stationary shaft, through which the paint is dispersed into a rotating bell or cup, in order to atomize the paint.

In current designs it is difficult to shield the rotor from physical contact. Any protection or protection fixing means that obstructs the output of the atomizer is bound to collect droplets, which will combine in a liquid film on the obstruction, and ultimately result in dripping. Dripping is considered a disadvantage in some applications.

Rotary atomizers are currently employed for evaporative cooling purposes, by atomizing liquid water in small droplets in order to facilitate evaporation. Some are based on the above mentioned metal foam disc design, and they atomize water into 20-100 micron droplets and disperse the droplets in a fan induced air current. As the water droplets evaporate in the air flow, the air flow's temperature drops and its relative humidity increases. Using a rotary atomizer for evaporative cooling has some specific requirements which are not met by current designs.

Evaporative cooling of large spaces, such as livestock and bird farms, industrial facilities, stadiums, stations, gardens or terraces requires prolonged periods of use (8 to 16 hours a day during the warm seasons). The metal foam disc nozzle design is not suited for this intensive usage, as the disc has a tendency to rupture and break after a while, due to exposure to large centrifugal forces and liquid pressures.

Furthermore, in the current designs the metal foam disc is cut from a sheet of meta foam. Given the relatively high cost of metal foam, cutting a disc from a metal foam sheet introduces substantial waste, and as such the production of these discs is not very cost effective.

There is a need for a rotary atomizer with a metal foam nozzle design that is economical, strong and safe.

### SUMMARY OF THE INVENTION

The invention is conceived by the need to provide a rotary atomizer that is effective in terms of droplet size distribution and flow rate, and strong enough to withstand 8 to 16 hours of use a day over a prolonged period of time. Disclosed is an atomizer in which pre-formed metal foam inserts are placed along the perimeter of the atomizer rotor and act as nozzles. The metal foam inserts are securely held in position by insert holders on the rotor.

It is another objective of the present invention to minimize the amount of metal foam required to provide an efficient nozzle for the atomizer. Blocks of metal foam are pre-formed and cleverly arranged to reduce the required amount of metal foam for production of a rotary atomizer.

It is a further objective of the invention to provide an atomizing unit that includes a protection plate, thus preventing physical contact with the rotor, without obstructing the atomizer output, A stationary protection surface which has an area larger than the rotor is used to achieve this purpose. The protection surface is connected to a stationary shaft which is connected to the housing of the rotary atomizer.

### BRIEF DESCRIPTION OF THE DRAWINGS

The invention will now be described in greater detail, by way of an example, with reference to the accompanying drawings, in which:

FIG. 1 illustrates a sectional view across the diameter of a rotary atomizer in accordance with an embodiment of the present invention;

FIG. 2 illustrates a perspective view of a rotary atomizer in accordance with an embodiment of the present invention;

FIG. 3 illustrates an exploded view of a rotary atomizer in accordance with an embodiment of the present invention;

FIG. 4 illustrates a perspective view of a rotor with metal foam inserts in accordance with the present invention; and

FIG. 5 illustrates a perspective view of a metal foam insert in accordance with the present invention.

### DETAILED DESCRIPTION OF THE DRAWINGS

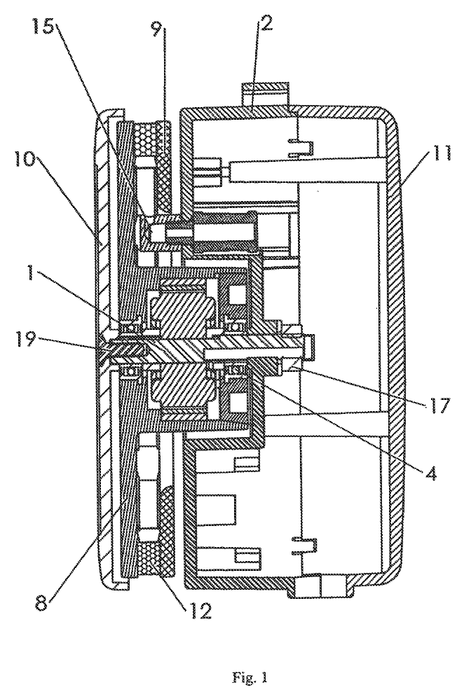

FIG. 1 shows a longitudinal cross sectional view of a rotary atomizer in accordance with an embodiment of the present invention. The rotary atomizer includes a stationary housing (2) with a housing cover (11), and a stationary shaft (1) fixed to housing (2) with a nut (17). A rotor (8), together with metal foam inserts (12) and a rotor back plate (9), is mounted on stationary shaft (1) with bearings (4), allowing free rotation around stationary shaft (1). A protection plate (10) is fixed on stationary shaft (1) with a screw (19). A liquid feed (15) is fixed on housing (2).

The speed with which rotor (8) rotates around stationary shaft (1) depends on the liquid to be atomized, and the required volume and droplet characteristics of the output. Speeds up to 20,000 rpm are not exceptional. Once rotor (8) is rotating at the required speed, the liquid to be atomized is fed though feed (15) into rotor (8).

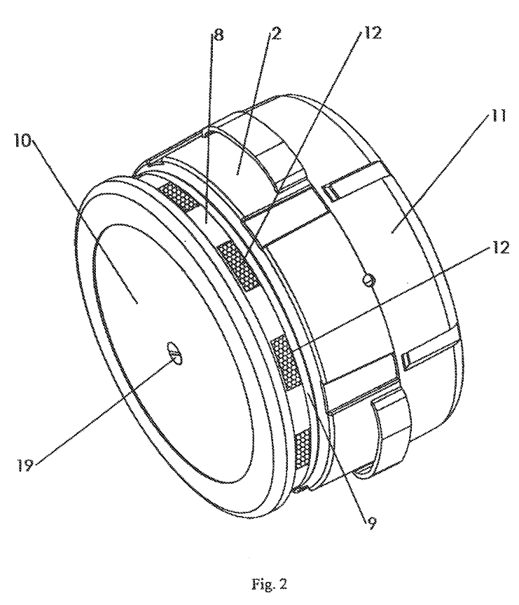

FIG. 2 illustrates a perspective view of a rotary atomizer in accordance with an embodiment of the present invention. The figure shows that whilst protection plate (10) prevents direct contact with rotor (8), there is no radial interference between the perimeter of rotor (8) and protection plate (10) or its fixing means, because protection plate (10) is mounted and fixed directly on stationary shaft (1). Any obstruction in contact with the output of the atomizer is bound to collect droplets, which will combine in a liquid film or the obstruction, and ultimately result in dripping.

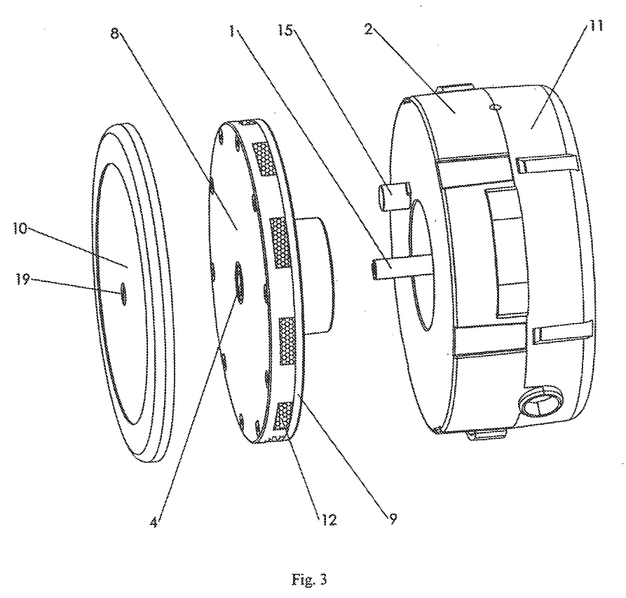

FIG. 3 illustrates an exploded view of a rotary atomizer in accordance with an embodiment of the present invention. The figure shows stationary housing (2) with liquid feed (15) and stationary shaft (1), rotor (8) with metal foam inserts (12) and rotor back plate (9), and protection plate (10) and fixing screw (19).

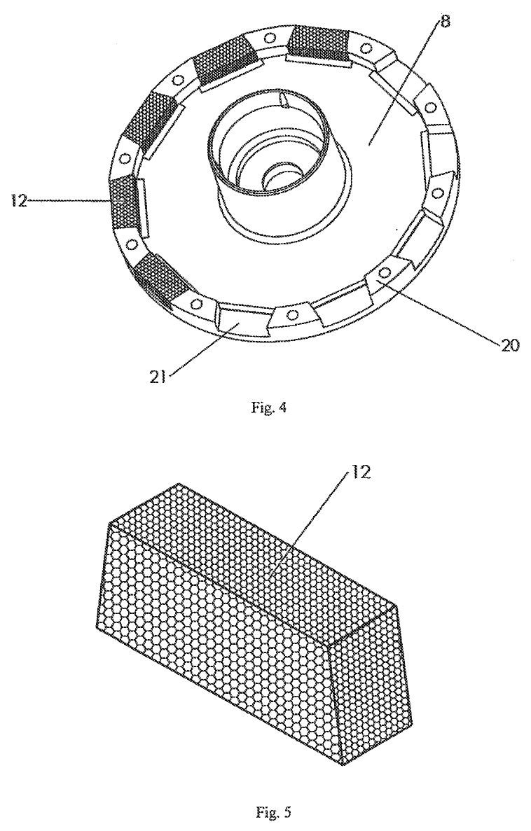

FIG. 4 shows an embodiment of a rotor (8) with metal foam inserts (12) acting as nozzles. Rotor (8) is shaped as a disc, with a plurality of insert holders (20) along the perimeter of rotor (8). Cavities (21) between consecutive insert holders (20) are pre-shaped to be fitted with metal foam inserts (12). Insert holders (20) are pre-shaped to secure the position of metal foam inserts (12) at cavities (21). Insert holders (20), cavities (21) and metal foam inserts (12) in the drawings are trapezium shaped. Other shapes and corresponding fits are possible. The shape of insert holder (20) is optimized to secure the position of metal foam inserts (12) when rotor (8) is rotated at a high revolution rate. Insert holders (20) and cavities (21) have uniform sizes and are spaced apart uniformly. Uniform position and size of insert holders (20) allows the atomizer to atomize liquid in a radial direction at equal flow rate and velocity.

FIG. 5 shows an embodiment of metal foam insert (12) in accordance with the present invention. Metal foam inserts (12) are preferably of uniform size, and uniformly spaced around the perimeter of rotor (8). Metal foam insert (12) may take the shape of a trapezium, a shape having two parallel sides or another unique shape. As the trapeziums can be cut from a metal foam sheet with minimal waste, the amount of metal foam required for the inserts is substantially less than if an axially apertured disc is cut from a sheet of foam. Metal foam inserts (12) are preferably made of a nickel alloy.

The present invention is suitable for various uses, such as the dispersing of liquids in general-liquid fertilizers, insecticides, scents, disinfectants, water, paint or oil. An important area of application of the invention is evaporative cooling, both indoors and outdoors.

The present invention offers specific advantages over other types of rotary atomizers.

One advantage of the present invention is that it provides a simple, robust and cost effective construction, Rotor (8) can be produced in volume to close tolerances by injection molding a glass filled engineering plastic.

Using trapezium shaped metal foam inserts (12) it is possible to out metal foam inserts (12) from a sheet of metal foam with minimum waste, thereby significantly reducing the atomizer's production cost.

Using trapezium shaped metal foam inserts (12) also significantly increases the lifespan of the atomizer, As the centrifugal force wedges metal foam inserts (12) between insert holders (20), they actually compress and become stronger, thereby preventing metal foam inserts (12) from rupturing or breaking loose.

Yet another advantage of the present invention is that it allows for a protection plate (10) to prevent physical contact with rotor (8), without interfering with the atomized output along the perimeter of rotor (8), thereby preventing liquid buildup and dripping.

While embodiments of the invention have been illustrated and described, it is not intended that these embodiments illustrate and describe all possible forms of the invention. Rather, the words used in the specifications are words of description rather than limitation and various changes may be made without departing from the scope of the invention.

1. A rotary atomizer comprising:
a rotor (8), having a plurality of insert holders (20); and
a plurality of metal foam inserts (12) placed between insert holders (20);
characterized in that the metal foam inserts (12) act as nozzles of a rotary atomizer, and
wherein insert holders (20) secure the position of metal foam inserts (12).

2. A rotary atomizer according to claim 1, wherein metal foam inserts (12) are made of a nickel alloy.

3. A rotary atomizer according to claim 1, wherein insert holders (20) are positioned along the perimeter of rotor (8).

4. A rotary atomizer according to claim 1, wherein rotor (8) is disc shaped.

5. A rotary atomizer according to claim 1, wherein insert holders (20) have two sides, if the sides are connected with imaginary lines, the lines will meet between insert holder (20) and the center of rotor (8).

6. A rotary atomizer according to claim 1, wherein insert holders (20) have two sides, if the sides are connected with imaginary lines, the lines will meet between insert holder (20) and the center of rotor (8), preferably nearer to insert holder (20).

7. A rotary atomizer according to claim 1, wherein insert holders (20) have uniform sizes and are spaced uniformly apart.

8. A rotary atomizer according to claim 1, wherein metal foam inserts (12) have uniform sizes and are spaced apart uniformly.

9. A rotary atomizer according to claim 1, wherein metal foam insert (12) is preferably of a shape having two parallel sides.

10. A rotary atomizer according to claim 1, wherein metal foam insert (12) is preferably of trapezium shape.

11. A rotary atomizer according to claim 1, wherein metal foam insert (12) is preferably of a shape that fits between consecutive insert holders (20).

12. A rotary atomizer according to claim 1, additionally comprising a rotor back plate (9) assembled on rotor (8) to further secure metal foam inserts (12).

13. A rotary atomizer comprising:
a housing (2);
a stationary shaft (1);
a protection plate (10); and
a rotor (8);
wherein housing (2) is stationary, and connected to stationary shaft (1) in an axial position, and
wherein protection plate (10) is stationary, and connected to the stationary shaft (1) in an axial position, and
wherein the axial position of rotor (8) on stationary shaft (1) is between axial position of atomizer housing (2) on stationary shaft (1) and axial position of protection plate (10) on stationary shaft (1), and
wherein rotor (8) rotates around stationary shaft (1).

14. A rotary atomizer according to claim 13, wherein protection plate (10) has an area larger than rotor (8).

15. A rotary atomizer according to claim 13, wherein protection plate (10) is a round plate with a diameter larger than the diameter of rotor (8).

16. A rotary atomizer according to any of the preceding claims, wherein the rotary atomizer is used for evaporative cooling purposes.
